(19) United States
(12) Patent Application Publication
(10) Pub. No.: US 2026/0212645 A1
(43) Pub. Date: Jul. 23, 2026

(54) MULTI-LABEL IMAGE CLASSIFICATION METHOD AND APPARATUS, AND MULTI-LABEL IMAGE CLASSIFICATION MODEL TRAINING METHOD AND APPARATUS

(71) Applicant: UNIDT (SHANGHAI) CO., LTD., Shanghai (CN)

(72) Inventors: Xiaomei WANG, Shanghai (CN); Yunhong LU, Shanghai (CN)

(21) Appl. No.: 19/138,869

(22) PCT Filed: Apr. 23, 2023
(86) PCT No.: PCT/CN2023/090036

§ 371 Date: Jun. 13, 2025

(30) Foreign Application Priority Data
Dec. 16, 2022 (CN) 202211626780.1

(51) Int. Cl. G06V 10/764; G06V 10/77; G06V 10/776; G06V 10/82

(52) U.S. Cl. CPC G06V 10/764; G06V 10/7715; G06V 10/776; G06V 10/82

(57) ABSTRACT

A multi-label image classification method and apparatus, and a multi-label image classification model training method and apparatus are provided. The training method includes: acquiring training samples including sample images and corresponding label sets each of which includes classification labels; acquiring semantic features of the label sets from the classification labels; inputting the sample images and semantic features into a multi-label image classification model, wherein the model acquires visual features based on a visual encoder, acquires correlation between the sample images and label sets by processing the visual and semantic features, and acquires a prediction result of mapping the sample images to the classification labels by processing the visual features; constructing a correlation matrix and corresponding unit matrix based on the correlation; calculating target loss based on the correlation matrix, the unit matrix, the prediction result and the classification labels, adjusting parameters of the model until convergence condition is met.

### CROSS-REFERENCE TO RELATED APPLICATIONS

This application claims priority to Chinese Patent Application No. 202211626780.1, filed on Dec. 16, 2022, and entitled “MULTI-LABEL IMAGE CLASSIFICATION METHOD AND APPARATUS, AND MULTI-LABEL IMAGE CLASSIFICATION MODEL TRAINING METHOD AND APPARATUS”, the entire disclosure of which is incorporated herein by reference.

### TECHNICAL FIELD

The present disclosure generally relates to image classification technology field, and more particularly, to a multi-label image classification method and apparatus, and a multi-label image classification model training method and apparatus.

### BACKGROUND

Image classification refers to a process of assigning a category label to an image from multiple pre-set category labels, which includes single-label classification and multi-label classification. Single-label classification includes assigning a single label to each image that best expresses content of the image, while multi-label classification includes assigning multiple category labels to each image. In comparison, multi-label image classification can better express the content of images and thus is more widely applied. However, existing image classification technologies generally classify images merely based on content. For multi-label image classification, misidentification and omission of identification labels easily occur, resulting in low accuracy.

### SUMMARY

Embodiments of the present disclosure provide a multi-label image classification method and apparatus, and a multi-label image classification model training method and apparatus, which may improve accuracy of multi-label image classification.

In an embodiment of the present disclosure, a multi-label image classification model training method is provided, including: acquiring a plurality of training samples, wherein the plurality of training samples include sample images and label sets corresponding to the sample images, and each of the label sets include at least two classification labels; acquiring semantic features of the label sets from the classification labels; inputting the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network; constructing a correlation matrix and a unit matrix corresponding to the correlation matrix based on the correlation; and calculating a target loss based on the correlation matrix, the unit matrix, the prediction result and the classification labels, and adjusting parameters of the multi-label image classification model based on the target loss until a convergence condition is met.

Optionally, the visual encoder includes a convolutional neural network and a Transformer network, and said acquiring the visual features from the sample images based on the visual encoder includes: inputting the sample images into the convolutional neural network for feature extraction to acquire a corresponding feature map; flattening the feature map to acquire a first feature; inputting the first feature into the Transformer network for encoding processing to acquire a second feature; and generating the visual features based on the second feature.

Optionally, said acquiring the semantic features of the label sets from the classification labels includes: inputting the classification labels into a semantic encoder for semantic mapping respectively to acquire semantic features of the classification is labels; acquiring weight parameters of the classification labels; and generating the semantic features of the label sets based on the weight parameters and the semantic features of the classification labels.

Optionally, said calculating the target loss based on the correlation matrix, the unit matrix, the prediction result and the classification labels includes: calculating a first loss based on the correlation matrix and the unit matrix; calculating a second loss based on the prediction result and the classification labels; and determining the target loss based on the first loss and the second loss.

Optionally, the first loss includes a row loss and a column loss, and said calculating the first loss based on the correlation matrix and the unit matrix includes: substituting the correlation matrix and the unit matrix into a first loss function to acquire the row loss, wherein the first loss function includes:

$${L}_{x} = \frac{1}{N} {\sum }_{i = 1}^{N} {\sum }_{j = 1}^{N} [ {e}_{i j} log ( σ ( {M}_{i j} ) ) + ( 1 - {e}_{i j} ) log ( 1 - σ ( {M}_{i j} ) ) ] ,$$

where Lₓ is the row loss, Mᵢⱼ is an element in i-th row and j-th column of the correlation matrix, eᵢⱼ is an element in i-th row and j-th column of the unit matrix, σ( ) is an activation function, and N is a number of the sample images; substituting the correlation matrix and the unit matrix into a second loss function to acquire the column loss, wherein the second loss function includes:

$${L}_{y} = \frac{1}{N} {\sum }_{i = 1}^{N} {\sum }_{j = 1}^{N} [ {e}_{j i} log ( σ ( {M}_{j i} ) ) + ( 1 - {e}_{j i} ) log ( 1 - σ ( {M}_{j i} ) ) ] ,$$

wherein L_{y} is the column loss, Mⱼᵢ is an element in j-th row and i-th column of the correlation matrix, eⱼᵢ is an element in j-th row and i-th column of the unit matrix, σ( ) is the activation function, and N is the number of the sample images; and determining the first loss based on the row loss and the column loss; and/or, said calculating a second loss based on the prediction result and the classification labels includes: substituting the prediction result and the classification labels into a third loss function to acquire the second loss, wherein the third loss function includes:

$${L}_{v} = \frac{1}{N} {\sum }_{k = 1}^{N} {\sum }_{t = 1}^{T} [ {g}_{kt} log ( σ ( {𝓋}_{kt} ) ) + ( 1 - {g}_{kt} ) log ( 1 - σ ( {𝓋}_{kt} ) ) ] ,$$

where Lᵥ is the second loss, gₖₜ is a true label value of a k-th sample image mapped to a t-h classification label, [symbol] ₖₜ is the prediction result value of the k-th sample image mapped to the t-th classification label, σ( ) is the activation function, N is the number of the sample images, and T is a number of the classification labels.

In an embodiment of the present disclosure, a multi-label image classification method is provided, including: acquiring a to-be-classified image and at least two candidate labels; acquiring semantic features of the at least two candidate labels from the at least two candidate labels; inputting the to-be-classified image and the semantic features of the at least two candidate labels into a multi-label image classification model for classification processing, to acquire a correlation between the to-be-classified image and the at least two candidate labels, and a prediction result of mapping the to-be-classified image to the at least two candidate labels, wherein the multi-label image classification model is acquired by the above method; and determining a classification result of the to-be-classified image based on the correlation and the prediction result.

In an embodiment of the present disclosure, a multi-label image classification model training apparatus is provided, including: a first acquisition circuitry configured to acquire a plurality of training samples, wherein the plurality of training samples include sample images and label sets corresponding to the sample images, and each of the label sets include at least two classification labels; a second acquisition circuitry configured to acquire semantic features of the label sets from the classification labels; a first classification circuitry configured to input the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network; a construction circuitry configured to construct a correlation matrix and a unit matrix corresponding to the correlation matrix based on the correlation; and a training circuitry configured to calculate a target loss based on the correlation matrix, the unit matrix, the prediction result and the classification labels, and adjust parameters of the multi-label image classification model based on the target loss until a convergence condition is met.

In an embodiment of the present disclosure, a multi-label image classification apparatus is provided, including: a third acquisition circuitry configured to acquire a to-be-classified image and at least two candidate labels; a fourth acquisition circuitry configured to acquire semantic features of the at least two candidate labels from the at least two candidate labels; a second classification circuitry configured to input the to-be-classified image and the semantic features of the at least two candidate labels into a multi-label image classification model for classification processing, to acquire a correlation between the to-be-classified image and the at least two candidate labels, and a prediction result of mapping the to-be-classified image to the at least two candidate is labels, wherein the multi-label image classification model is acquired by the above apparatus; and a classification result determination circuitry configured to determine a classification result of the to-be-classified image based on the correlation and the prediction result.

In an embodiment of the present disclosure, an electronic device is provided, which includes a memory, a processor, and a computer program stored in the memory and configured to run on the processor, where when the processor executes the computer program, any one of the above methods is implemented.

In an embodiment of the present disclosure, a computer readable storage medium having computer instructions stored therein is provided, where when the computer instructions are executed by a processor, any one of the above methods is implemented.

On the basis of being in accordance with common sense in the art, the above-mentioned optional conditions can be arbitrarily combined to acquire embodiments of the present disclosure.

Embodiments of the present disclosure may provide following advantages.

The semantic information in the labels is utilized to acquire the semantic information of the label sets corresponding to the images in advance. During the training of the model, in addition to training the prediction result of the labels corresponding to image information, the correlation between the image information and the semantic information of the label sets is also learned, thereby acquiring a highly accurate multi-label image classification model, which effectively improves accuracy of multi-label image classification. In addition, by jointly optimizing the model with multiple loss functions, it is ensured that the image classification model can converge to an optimal solution, further improving the accuracy of multi-label image classification.

### BRIEF DESCRIPTION OF THE DRAWINGS

FIG. 1 is a flow chart of a multi-label image classification model training method according to an embodiment;

FIG. 2 is a framework diagram of acquiring semantic features by a semantic encoder in the multi-label image classification model training method illustrated in FIG. 1;

FIG. 3 is a framework diagram of acquiring visual features by a visual encoder in the multi-label image classification model training method illustrated in FIG. 1;

FIG. 4 is a framework diagram of training a contrastive learning network in the multi-label image classification model training method illustrated in FIG. 1;

FIG. 5 is a flow chart of a multi-label image classification method according to an embodiment;

FIG. 6 is a framework diagram of acquiring semantic features by a semantic encoder in the multi-label image classification method illustrated in FIG. 5;

FIG. 7 is a framework diagram of the multi-label image classification method illustrated in FIG. 5;

FIG. 8 is a framework diagram of acquiring correlation through a contrastive learning network in the multi-label image classification method illustrated in FIG. 5;

FIG. 9 is a block diagram of a multi-label image classification model training apparatus according to an embodiment;

FIG. 10 is a block diagram of a multi-label image classification apparatus according to an embodiment; and

FIG. 11 is a block diagram of an electronic device according to an embodiment.

### DETAILED DESCRIPTION

The present disclosure is further described below via embodiments, but the present disclosure is not limited to the scope of the embodiments.

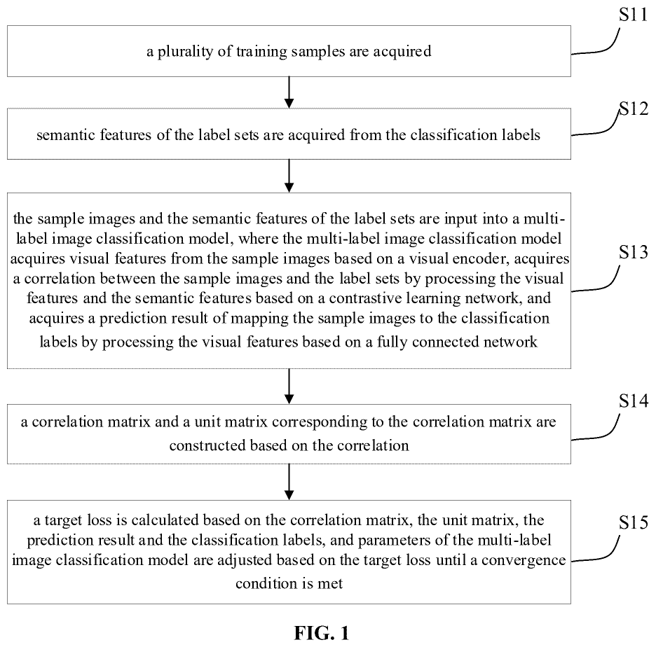

An embodiment provides a multi-label image classification model training method. As illustrated in FIG. 1, the method includes S11 to S15.

In S11, a plurality of training samples are acquired.

The plurality of training samples include sample images and label sets corresponding to the sample images, and each of the label sets includes at least two classification labels.

In the embodiment, each training sample includes one sample image and one label set corresponding to the sample image. The sample image may be taken by a device or crawled from the Internet. The sample image may include multiple different categories of image information. For example, a landscape image includes image information such as the sun, clouds, mountains, and rivers. Different image information in the sample image is labeled (i.e., with classification labels) to acquire a label set corresponding to the sample image.

In an optional embodiment, to better extract features of the sample images, the sample images are preprocessed, such as scaling the sample images with a same short side size, and then normalizing pixels of the sample images, that is, mapping the pixels to a range from 0 to 1, thereby eliminating influence of unit and scale differences in the image features. In addition, some color jittering operations may be performed to enhance the color of the images by adjusting the brightness, saturation and contrast of the images to eliminate differences of the images in different backgrounds, etc. The embodiment is not limited to the above-mentioned image preprocessing operations.

In S12, semantic features of the label sets are acquired from the classification labels.

In the embodiment, the label sets are encoded to acquire the semantic features of the label sets. In an optional embodiment, the classification labels are respectively input into a semantic encoder for semantic mapping to acquire the semantic features of the classification labels. Then weight parameters of each classification label are acquired. Finally, the semantic features of the label sets are generated based on the weight parameters and the semantic features of the classification labels.

For example, as illustrated in FIG. 2, assuming that the label set corresponding to a particular image includes t classification labels, these k classification is labels are input into the semantic encoder for semantic mapping to acquire semantic features with a dimension of t×d. In an optional embodiment, the semantic mapping may use relevant models which map each word to generate semantic features, such as Glove, Bert, ELMo and word2vec (some classic word vector models). As the semantic encoder also includes guessing words in adjacent positions when performing semantic mapping, the semantic features are also used to characterize a correlation between classification labels.

In an optional embodiment, to acquire the semantic feature of the label set, the semantic encoder is further configured to acquire a weight parameter of each classification label. Referring to FIG. 2, the t×d semantic features are fused into a 1×d semantic feature by weighted averaging. That is, the semantic feature of each classification label is multiplied by the corresponding weight parameter, and then an average is taken to acquire the semantic feature of the label set, where a sum of the weight parameters of all classification labels under the label set is 1.

In S13, the sample images and the semantic features of the label sets are input into a multi-label image classification model, where the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network.

In the embodiment, the sample images are encoded, that is, the visual features of the sample images are acquired, and the visual features can be acquired from the is sample images through the visual encoder of the multi-label image classification model. In an optional embodiment, the visual encoder includes a convolutional neural network and a Transformer network. The sample images may be input into the convolutional neural network for feature extraction to acquire a corresponding feature map. Then the feature map is flattened to acquire a first feature to be input into the Transformer network for encoding processing to acquire a second feature. Finally, the visual features are generated based on the second feature.

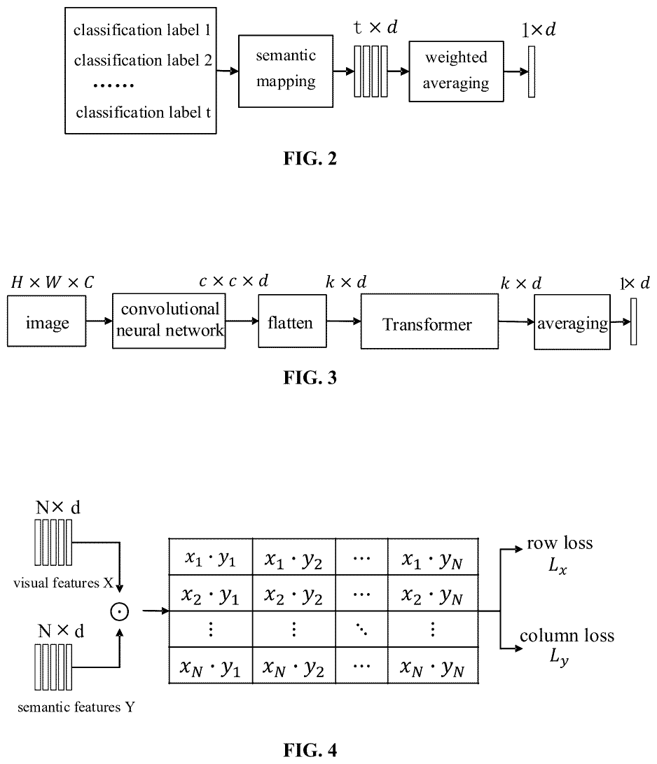

For example, as illustrated in FIG. 3, a sample image of H×W×C is input into a convolutional neural network for feature extraction, where H is height of the sample image, W is width of the sample image, and C is a number of channels of the sample image. Generally, C=3, which corresponds to three channels of R, G, and B. If it is a grayscale image, there is a single channel with the number of channels C=1. The convolutional neural network includes multiple convolutional layers, which extract local features of the sample image in a hierarchical form through convolution operations. Output of the last convolutional layer is acquired to acquire a feature map with a feature dimension of c×c×d. In an optional embodiment, the convolutional neural network can adopt structures such as a VGG network (a classic convolutional neural network) and a Resnet network (a residual network).

Referring to FIG. 3, the feature map with a feature dimension of c×c×d is flattened into a first feature of k×d, where k=c². Afterward, the first feature is sent to the Transformer network for further encoding processing to acquire a second feature with a feature dimension of k×d. The Transformer network can reflect complex spatial transformations and long-distance relationships between visual elements, etc., thereby forming a global representation. In the embodiment, the features output by the visual encoder through the convolutional neural network and the Transformer network can take into account both local feature details and global representation, which is more conducive to subsequent image classification.

In an optional embodiment, the 1×d visual features of the sample images are acquired by taking an average value of the k×d second features.

It should be noted that the semantic encoder in the embodiment is pre-trained, while the visual encoder is generated by learning during the training of the multi-label image classification model.

In the embodiment, a contrastive learning network and a fully connected network are introduced into the multi-label image classification model. After the visual features and semantic features are acquired, two branches are provided for further processing. One branch is to input the visual features and the semantic features into the contrastive learning network, and process the visual features and the semantic features based on the contrastive learning network to acquire the correlation between the sample images and the label sets. The other branch is to send the visual features to the fully connected network for fully connected mapping, so as to process the visual features based on the fully connected network to acquire the prediction result of mapping the sample images to the classification labels (i.e., prediction probability of each classification label).

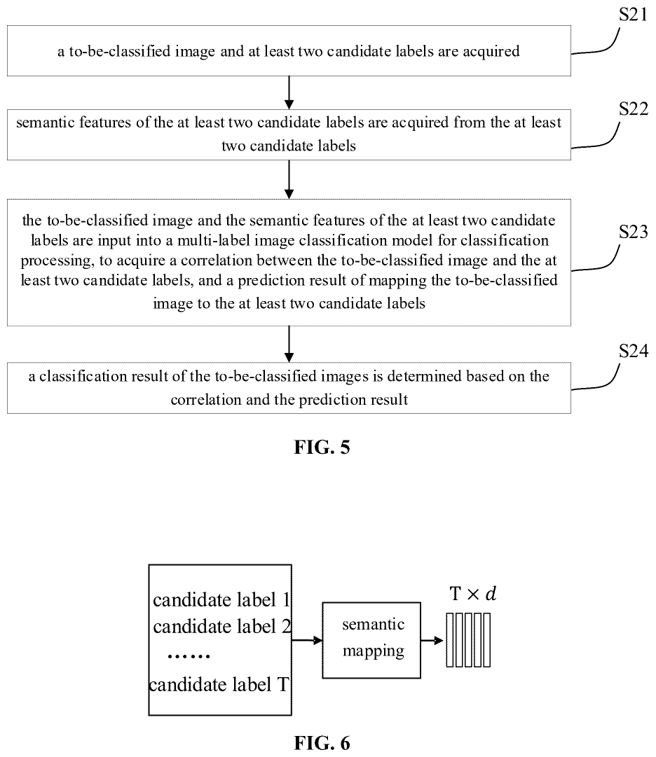

In an optional embodiment, core content of the contrastive learning network in the training stage is illustrated in FIG. 4. There are N training samples including N sample images and N corresponding label sets. The N×d visual features X and the N×d semantic features Y are multiplied one by one to acquire cosine similarity (i.e., the correlation between the sample images and the label sets). The cosine similarity is represented by xᵢ·yⱼ, and xᵢ·yⱼ=|xᵢ∥yⱼ| cos θ, where xᵢ represents the i-th visual feature and yⱼ represents the j-th semantic feature. For example, assuming there are two training samples, the cosine similarity includes x₁·y₁, x₁·y₂, x₂·y₁ and x₂·y₂.

In S14, a correlation matrix and a unit matrix corresponding to the correlation matrix are constructed based on the correlation.

The correlation matrix is illustrated in FIG. 4, where the visual features and the semantic features which constitute matching pairs are set on a diagonal from an upper left corner to a lower right corner. As it is necessary to maximize the cosine similarity between the visual features of the sample images and the semantic features of the corresponding matching label sets, and minimize the cosine similarity between the visual features and the semantic features of non-matching pairs during the training, the unit matrix is required. The unit matrix has following characteristics. Elements on the diagonal from the upper left corner to the lower right corner are all 1, other elements are all 0, and any matrix multiplied by the unit matrix is equal to the matrix itself, which has a special function.

For example, assuming there are N visual features and N corresponding semantic features, N×N cosine similarity is acquired, thereby constructing a cosine similarity matrix (i.e., a correlation matrix) with a dimension of N×N and a unit matrix with a dimension of N×N.

In S15, a target loss is calculated based on the correlation matrix, the unit matrix, the prediction result and the classification labels, and parameters of the multi-label image classification model are adjusted based on the target loss until a convergence condition is met.

In the embodiment, the first loss is calculated based on the correlation matrix and the unit matrix, the second loss is calculated based on the prediction result and the corresponding classification labels, and the target loss is determined based on the first loss and the second loss.

In an optional embodiment, the first loss includes a row loss and a column loss, and cross entropy loss is performed on the semantic features and the visual features respectively, that is, values on the diagonal are maximized from the rows and columns of the correlation matrix respectively, thereby acquiring the row loss Lₓ and the column loss L_{y} respectively. Specifically, the correlation matrix and the unit matrix are substituted into the first loss function to acquire the row loss, where a calculation formula of the first loss function includes:

$${L}_{x} = \frac{1}{N} {\sum }_{i = 1}^{N} {\sum }_{j = 1}^{N} [ {e}_{i j} log ( σ ( {M}_{i j} ) ) + ( 1 - {e}_{i j} ) log ( 1 - σ ( {M}_{i j} ) ) ] ,$$

where Lₓ is the row loss, Mᵢⱼ is an element in i-th row and j-th column of the correlation matrix, eᵢⱼ is an element in i-th row and j-th column of the unit matrix, σ( ) is an activation function, and N is a number of the sample images.

The correlation matrix and the unit matrix are substituted into a second loss function to acquire the column loss, where the second loss function includes:

$${L}_{y} = \frac{1}{N} {\sum }_{i = 1}^{N} {\sum }_{j = 1}^{N} [ {e}_{j i} log ( σ ( {M}_{j i} ) ) + ( 1 - {e}_{j i} ) log ( 1 - σ ( {M}_{j i} ) ) ] ,$$

where L_{y} is the column loss, Mⱼᵢ is an element in j-th row and i-th column of the correlation matrix, eⱼᵢ is an element in j-th row and i-th column of the unit matrix, σ( ) is the activation function, and N is the number of the sample images.

The first loss is determined based on the row loss and the column loss. In an optional embodiment, the first loss is acquired by averaging the row loss and the column loss. In another optional embodiment, the rows and the columns of the correlation matrix are traversed respectively to calculate the row loss and the column loss, that is, traversal orders are different. Ideally, Lₓ=L_{y}, and Lₓ and L_{y} are only different in meaning. Therefore, the row loss or the column loss can be directly used as the first loss to reduce the amount of calculation. The first loss L_{xy}=Lₓ=L_{y}, or L_{xy}=(Lₓ+L_{y})/2. In practice, to ensure accuracy of the model, L_{xy}=(Lₓ+L_{y})/2.

In an optional embodiment, a cross entropy loss (i.e., the second loss) is calculated based on the prediction result and the classification labels corresponding to the sample images. Specifically, the prediction result and the corresponding classification labels are substituted into the third loss function to acquire the second loss. A calculation formula of the third loss function includes:

$${L}_{v} = \frac{1}{N} {\sum }_{k = 1}^{N} {\sum }_{t = 1}^{T} [ {g}_{kt} log ( σ ( {𝓋}_{kt} ) ) + ( 1 - {g}_{kt} ) log ( 1 - σ ( {𝓋}_{kt} ) ) ] ,$$

where Lᵥ is the second loss, gₖₜ is a true label value (i.e., “0” or “1”) of a k-th sample image mapped to a t-h classification label, [symbol] ₖₜ is the prediction result value of the k-th sample image mapped to the t-th classification label, σ( ) is the activation function, N is the number of the sample images, and T is a number of the classification labels.

In an optional embodiment, there may be a problem of sample imbalance in the training samples, such as complex sample images or uncommon labels, etc. During the model training process, greater weights may be given to difficult samples to focus on learning difficult samples.

The first loss and the second loss are combined to acquire the total loss (i.e., a target loss) of the multi-label image classification model. The parameters of the multi-label image classification model are adjusted by back-propagating the target loss until the multi-label image classification model meets the convergence condition. In an optional embodiment, the convergence condition may be that the target loss is less than a preset threshold. By presetting a relatively small loss threshold, when the target loss is less than the set loss threshold, the multi-label image classification model is determined to have converged. In another optional embodiment, the convergence condition may be that a number of iterations of the multi-label image classification model training is greater than a preset iteration number. By presetting a relatively large iteration number, when the number of iterations of the multi-label image classification model training is greater than the set iteration number, the multi-label image classification model is determined to have converged.

In an optional embodiment, a learnable hyperparameter λ is set to coordinate the weights of the first loss and the second loss in the training of the multi-label image classification model. λ represents the target loss, having a value between 0 and 1. A calculation formula is as follows:

$$L = λ {L}_{v} + ( 1 - λ ) {L}_{x y} .$$

In an optional embodiment, in an early stage of multi-label image classification model training, λ is preset with a smaller value, and as the number of iterations of the multi-label image classification model training increases, the value of λ is gradually increased, and iterative training is continued. The embodiment is not limited to the above-mentioned parameter adjustment method, and alternatively manual parameter adjustment may be performed according to actual conditions.

In an optional embodiment, an optimization goal of the multi-label image classification model is to minimize the target loss. A target threshold of the target loss L is set. Iterative training is performed, and the multi-label image classification model is determined to converge when the value of the target loss L is lower than the target threshold and the model parameters change very little.

The embodiment has following beneficial effects.

The semantic information in the labels is utilized to acquire the semantic information of the label sets corresponding to the images in advance. During the training of the model, in addition to training the prediction result of the labels corresponding to image information, the correlation between the image information and the semantic information of the label sets is also learned, thereby acquiring a highly accurate multi-label image classification model, which effectively improves accuracy of multi-label image classification. In addition, by jointly optimizing the model with multiple loss functions, it is ensured that the image classification model can converge to an optimal solution, further improving the accuracy of multi-label image classification.

An embodiment provides a multi-label image classification method. As illustrated in FIG. 5, the multi-label image classification method includes S21 to S23.

In S21, a to-be-classified image and at least two candidate labels are acquired.

In S22, semantic features of the at least two candidate labels are acquired is from the at least two candidate labels.

In an optional embodiment, all candidate labels are input into a semantic encoder for semantic mapping to acquire semantic features of the candidate labels. As illustrated in FIG. 6, there are T candidate labels, and accordingly semantic features with a dimension of T×d are acquired.

In S23, the to-be-classified image and the semantic features of the at least two candidate labels are input into a multi-label image classification model for classification processing, to acquire a correlation between the to-be-classified image and the at least two candidate labels, and a prediction result of mapping the to-be-classified image to the at least two candidate labels.

The multi-label image classification model is acquired by the above method as illustrated in FIG. 1.

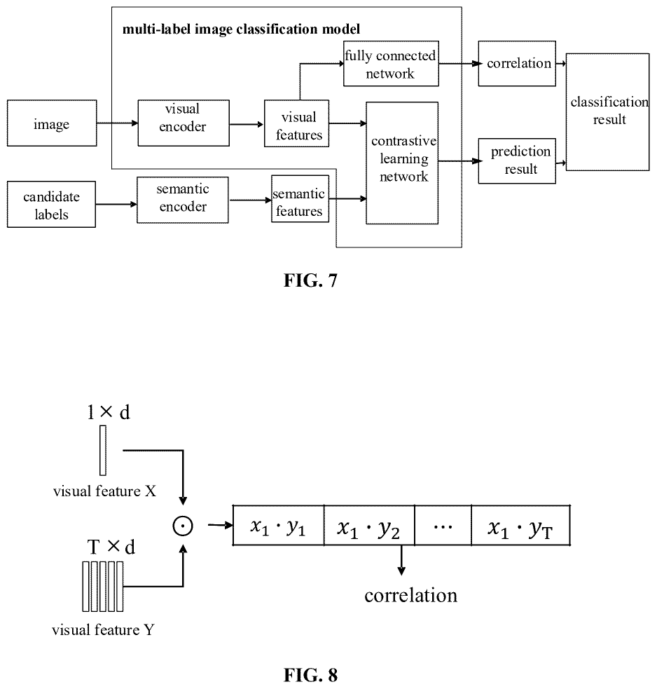

In the embodiment, as illustrated in FIG. 7, an image (i.e., the to-be-classified image) is input into a visual encoder of the multi-label image classification model to acquire visual features, and all candidate labels are input into the semantic encoder to acquire the semantic features. After the visual features and the semantic features are acquired, two branches are provided. One branch is to input the visual features and the semantic features into a trained contrastive learning network to acquire a correlation between the image to be classified and each candidate label. The other branch is to send the visual features to a fully connected network for fully connected mapping to acquire the prediction result of mapping the to-be-classified image to each classification label (i.e., prediction probability of each classification label).

In an optional embodiment, core content of the contrastive learning network in the prediction stage is illustrated in FIG. 8. The 1×d visual features X and the T×d semantic features Y are multiplied one by one to calculate cosine similarity of the visual features on each candidate label (that is, a correlation between the to-be-classified image and each candidate label). Referring to FIG. 8, assuming that there are T candidate labels, the cosine similarity includes x₁·y₁, x₁·y₂, . . . x₁·y_{T}.

In S24, a classification result of the to-be-classified images is determined based on the correlation and the prediction result.

After the prediction result of the fully connected network and the correlation of the contrastive learning network are acquired respectively, the classification result of the to-be-classified image may be p=λpᵥ+(1−λ)p_{d}, where pᵥ is the prediction result of the fully connected network, p_{d} is the correlation of the contrastive learning network, and λ is a weight parameter having a same value as the learnable hyperparameter in the training stage. The learnable hyperparameter λ in the training stage may be adjusted according to the classification result.

In an optional embodiment, a label threshold of the classification result may be set according to actual conditions. For example, if the classification result is above 0.5, it indicates that the candidate label is a label corresponding to the to-be-classified image.

For example, assuming that the candidate labels of the to-be-classified image include hats, tops, pants, shoes, scarves and skirts, the correlation between the to-be-classified image and the candidate labels is acquired as [0.1, 0.2, 0.3, 0.7, 0.5, 0.6] through classification performed by the multi-label image classification model. And the prediction result of the to-be-classified image being mapped to the candidate labels is [0.3, 0.2, 0.4, 0.4, 0.3, 0.6]. If λ is 0.5, the classification result is calculated to be [0.15, 0.2, 0.35, 0.55, 0.4, 0.6], where these values correspond to hats, tops, pants, shoes, scarves and skirts in order, and the candidate labels with a value greater than 0.5 are set as the labels of the to-be-classified image. From above, the traditional fully connected network predicts that the label of the to-be-classified image is only skirt, while the labels of the to-be-classified image acquired in the embodiment include shoes and skirt.

The embodiment has following beneficial effects.

In the embodiment, the semantic information of the candidate labels is introduced, and the multi-label classification model used for classification processing is acquired by the multi-label image classification model training method provided in the embodiment as illustrated in FIG. 1. When the multi-label image classification model is applied to a specific classification task, in addition to the traditional prediction result, the correlation between the image information and the semantic information of the candidate labels is improved by the contrastive learning network, and accordingly the multi-label image classification result output by the model is more accurate.

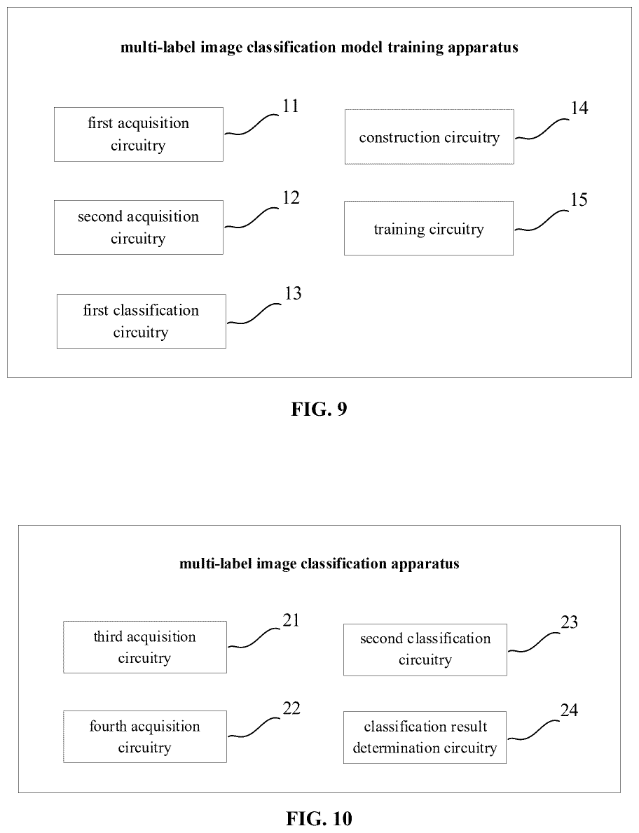

An embodiment of the present disclosure provides a multi-label image classification model training apparatus. As illustrated in FIG. 9, the apparatus includes: a first acquisition circuitry 11, a second acquisition circuitry 12, a first classification circuitry 13, a construction circuitry 14, and a training circuitry 15.

The first acquisition circuitry 11 is configured to acquire a plurality of training samples. The plurality of training samples include sample images and label sets corresponding to the sample images, and each of the label sets include at least two classification labels.

In the embodiment, each training sample includes one sample image and one label set corresponding to the sample image. The sample image may be taken by a device or crawled from the Internet. The sample image may include multiple different categories of image information. For example, a landscape image includes image information such as the sun, clouds, mountains, and rivers. Different image information in the sample image is labeled (i.e., with classification labels) to acquire a label set corresponding to the sample image.

In an optional embodiment, to better extract features of the sample images, the first acquisition circuitry 11 preprocesses the sample images, such as scaling the sample images with a same short side size, and then normalizing pixels of the sample images, that is, mapping the pixels to a range from 0 to 1, thereby eliminating influence of unit and scale differences in the image features. In addition, some color jittering operations may be performed to enhance the color of the images by adjusting the brightness, saturation and contrast of the images to eliminate differences of the images in different backgrounds, etc. The embodiment is not limited to the above-mentioned image preprocessing operations.

The second acquisition circuitry 12 is configured to acquire semantic features of the label sets from the classification labels. In the embodiment, the label sets are encoded to acquire the semantic features of the label sets. In an optional embodiment, the second acquisition circuitry 12 inputs the classification labels respectively into a semantic encoder for semantic mapping to acquire the semantic features of the classification labels. The second acquisition circuitry 12 further acquires weight parameters of each classification label, and generates the semantic features of the label sets based on the weight parameters and the semantic features of the classification labels.

For example, as illustrated in FIG. 2, assuming that the label set corresponding to a particular image includes t classification labels, these k classification labels are input into the semantic encoder for semantic mapping to acquire semantic features with a dimension of t×d. In an optional embodiment, the semantic mapping may use relevant models which map each word to generate semantic features, such as Glove, Bert, ELMo and word2vec (some classic word vector models). As the semantic encoder also includes guessing words in adjacent positions when performing semantic mapping, the semantic features are also used to characterize a correlation between classification labels.

In an optional embodiment, to acquire the semantic feature of the label set, the semantic encoder is further configured to acquire a weight parameter of each classification label. Referring to FIG. 2 and FIG. 9, the second acquisition circuitry 12 fuses the t×d semantic features into a 1×d semantic feature by weighted averaging. That is, the semantic feature of each classification label is multiplied by the corresponding weight parameter, and then an average is taken to acquire the semantic feature of the label set, where a sum of the weight parameters of all classification labels under the label set is 1.

Referring to FIG. 9, the first classification circuitry 13 is configured to input the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network.

In the embodiment, the first classification circuitry 13 is further configured to encode the sample images, that is, to acquire the visual features of the sample images, where the visual features can be acquired from the sample images through the visual encoder of the multi-label image classification model. In an optional embodiment, the visual encoder includes a convolutional neural network and a Transformer network. The sample images may be input into the convolutional neural network for feature extraction to acquire a corresponding feature map. Then the feature map is flattened to acquire a first feature to be input into the Transformer network for encoding processing to acquire a second feature. Finally, the visual features are generated based on the second feature.

For example, referring to FIG. 3 and FIG. 9, the first classification circuitry 13 inputs a sample image of H×W×C into a convolutional neural network for feature extraction, where H is height of the sample image, W is width of the sample image, and C is a number of channels of the sample image. Generally, C=3, which corresponds to three channels of R, G, and B. If it is a grayscale image, there is a single channel with the number of channels C=1. The convolutional neural network includes multiple convolutional layers, which extract local features of the sample image in a hierarchical form through convolution operations. The first classification circuitry 13 acquires output of the last convolutional layer to acquire a feature map with a feature dimension of c×c×d. In an optional embodiment, the convolutional neural network can adopt structures such as a VGG network (a classic convolutional neural network) and a Resnet network (a residual network).

Referring to FIG. 3, the first classification circuitry 13 flattens the feature map with a feature dimension of c×c×d into a first feature of k×d, where k=c². Afterward, the first classification circuitry 13 sends the first feature to the Transformer network for further encoding processing to acquire a second feature with a feature dimension of k×d. The Transformer network can reflect complex spatial transformations and long-distance relationships between visual elements, etc., thereby forming a global representation. In the embodiment, the features output by the visual encoder through the convolutional neural network and the Transformer network can take into account both local feature details and global representation, which is more conducive to subsequent image classification.

In an optional embodiment, the first classification circuitry 13 acquires the 1×d visual features of the sample images by taking an average value of the k×d second features.

It should be noted that the semantic encoder in the embodiment is pre-trained, while the visual encoder is generated by learning during the training of the multi-label image classification model.

In the embodiment, a contrastive learning network and a fully connected network are introduced into the multi-label image classification model. After the visual features and semantic features are acquired, the first classification circuitry 13 inputs the visual features and the semantic features into the contrastive learning network, and processes the visual features and the semantic features based on the contrastive learning network to acquire the correlation between the sample images and the label sets. The first classification circuitry 13 further sends the visual features to the fully connected network for fully connected mapping, so as to process the visual features based on the fully connected network to acquire the prediction result of mapping the sample images to the classification labels (i.e., prediction probability of each classification label).

In an optional embodiment, core content of the contrastive learning network in the training stage is illustrated in FIG. 4. There are N training samples including N sample images and N corresponding label sets. The first classification circuitry 13 multiplies the N×d visual features X with the N×d semantic features Y one by one to acquire cosine similarity (i.e., the correlation between the sample images and the label sets). The cosine similarity is represented by xᵢ·yⱼ, and xᵢ·yⱼ=|xᵢ∥yⱼ| cos θ, where xᵢ represents the i-th visual feature and yⱼ represents the j-th semantic feature. For example, assuming there are two training samples, the cosine similarity includes x₁·y₁, x₁·y₂, x₂·y₁ and x₂·y₂.

Referring to FIG. 9, the construction circuitry 14 is configured to construct a correlation matrix and a unit matrix corresponding to the correlation matrix based on the correlation. The correlation matrix is illustrated in FIG. 4, where the visual features and the semantic features which constitute matching pairs are set on a diagonal from an upper left corner to a lower right corner. As it is necessary to maximize the cosine similarity between the visual features of the sample images and the semantic features of the corresponding matching label sets, and minimize the cosine similarity between the visual features and the semantic features of non-matching pairs during the training, the construction circuitry 14 further needs to construct the unit matrix. The unit matrix has following characteristics. Elements on the diagonal from the upper left corner to the lower right corner are all 1, other elements are all 0, and any matrix multiplied by the unit matrix is equal to the matrix itself, which has a special function.

For example, assuming there are N visual features and N corresponding semantic features, N×N cosine similarity is acquired, thereby the construction circuitry 14 constructing a cosine similarity matrix (i.e., a correlation matrix) with a dimension of N×N and a unit matrix with a dimension of N×N.

Referring to FIG. 9, the training circuitry 15 is configured to calculate a target loss based on the correlation matrix, the unit matrix, the prediction result and the classification labels, and adjust parameters of the multi-label image classification model based on the target loss until a convergence condition is met. In the embodiment, the training circuitry 15 calculates the first loss based on the correlation matrix and the unit matrix, calculates the second loss based on the prediction result and the corresponding classification labels, and determines the target loss based on the first loss and the second loss.

In an optional embodiment, the first loss includes a row loss and a column loss. The training circuitry 15 performs cross entropy loss on the semantic features and the visual features respectively, that is, maximizing values on the diagonal from the rows and columns of the correlation matrix respectively, thereby acquiring the row loss Lₓ and the column loss L_{y} respectively. Specifically, the training circuitry 15 substitutes the correlation matrix and the unit matrix into the first loss function to acquire the row loss, where a calculation formula of the first loss function includes:

$${L}_{x} = \frac{1}{N} {\sum }_{i = 1}^{N} {\sum }_{j = 1}^{N} [ {e}_{i j} log ( σ ( {M}_{i j} ) ) + ( 1 - {e}_{i j} ) log ( 1 - σ ( {M}_{i j} ) ) ] ,$$

where Lₓ is the row loss, Mᵢⱼ is an element in i-th row and j-th column of the correlation matrix, eᵢⱼ is an element in i-th row and j-th column of the unit matrix, σ( ) is an activation function, and N is a number of the sample images.

The training circuitry 15 substitutes the correlation matrix and the unit matrix into a second loss function to acquire the column loss, where the second loss function includes:

$${L}_{y} = \frac{1}{N} {\sum }_{i = 1}^{N} {\sum }_{j = 1}^{N} [ {e}_{j i} log ( σ ( {M}_{j i} ) ) + ( 1 - {e}_{j i} ) log ( 1 - σ ( {M}_{j i} ) ) ] ,$$

where L_{y} is the column loss, Mⱼᵢ is an element in j-th row and i-th column of the correlation matrix, eⱼᵢ is an element in j-th row and i-th column of the unit matrix, σ( ) is the activation function, and N is the number of the sample images.

The training circuitry 15 determines the first loss based on the row loss and the column loss. In an optional embodiment, the training circuitry 15 acquires the first loss by averaging the row loss and the column loss. In another optional embodiment, the rows and the columns of the correlation matrix are traversed respectively to calculate the row loss and the column loss, that is, traversal orders are different. Ideally, Lₓ=L_{y}, and Lₓ and L_{y} are only different in meaning. Therefore, the training circuitry 15 can directly use the row loss or the column loss as the first loss to reduce the amount of calculation. The first loss L_{xy}=Lₓ=L_{y}, or L_{xy}=(Lₓ+L_{y})/2. In practice, to ensure accuracy of the model, L_{xy}=(Lₓ+L_{y})/2.

In an optional embodiment, the training circuitry 15 calculates a cross entropy loss (i.e., the second loss) based on the prediction result and the classification labels corresponding to the sample images. Specifically, the training circuitry 15 substitutes the prediction result and the corresponding classification labels into the third loss function to acquire the second loss. A calculation formula of the third loss function includes:

$${L}_{v} = \frac{1}{N} {\sum }_{k = 1}^{N} {\sum }_{t = 1}^{T} [ {g}_{kt} log ( σ ( {𝓋}_{kt} ) ) + ( 1 - {g}_{kt} ) log ( 1 - σ ( {𝓋}_{kt} ) ) ] ,$$

where Lᵥ is the second loss, gₖₜ is a true label value (i.e., “0” or “1”) of a k-th sample image mapped to a t-h classification label, [symbol] ₜ is the prediction result value of the k-th sample image mapped to the t-th classification label, σ( ) is the activation function, N is the number of the sample images, and T is a number of the classification labels.

In an optional embodiment, there may be a problem of sample imbalance in the training samples, such as complex sample images or uncommon labels, etc. During the model training process, greater weights may be given to difficult samples to focus on learning difficult samples.

The training circuitry 15 combines the first loss and the second loss to acquire the total loss (i.e., a target loss) of the multi-label image classification model. The training circuitry 15 adjusts the parameters of the multi-label image classification model by back-propagating the target loss until the multi-label image classification model meets the convergence condition. In an optional embodiment, the convergence condition may be that the target loss is less than a preset threshold. By presetting a relatively small loss threshold, when the target loss is less than the set loss threshold, the multi-label image classification model is determined to have converged. In another optional embodiment, the convergence condition may be that a number of iterations of the multi-label image classification model training is greater than a preset iteration is number. By presetting a relatively large iteration number, when the number of iterations of the multi-label image classification model training is greater than the set iteration number, the multi-label image classification model is determined to have converged.

In an optional embodiment, the training circuitry 15 sets a learnable hyperparameter λ to coordinate the weights of the first loss and the second loss in the training of the multi-label image classification model. λ represents the target loss, having a value between 0 and 1. A calculation formula is as follows:

$$L = λ {L}_{v} + ( 1 - λ ) {L}_{x y} .$$

In an optional embodiment, in an early stage of multi-label image classification model training, λ is preset with a smaller value, and as the number of iterations of the multi-label image classification model training increases, the training circuitry 15 gradually increases the value of λ, and continues iterative training. The embodiment is not limited to the above-mentioned parameter adjustment method, and alternatively manual parameter adjustment may be performed according to actual conditions.

In an optional embodiment, an optimization goal of the multi-label image classification model is to minimize the target loss. The training circuitry 15 sets a target threshold of the target loss L. Iterative training is performed, and the multi-label image classification model is determined to converge when the value of the target loss L is lower than the target threshold and the model parameters change very little.

An embodiment of the present disclosure provides a multi-label image classification apparatus. As illustrated in FIG. 10, the apparatus includes: a third acquisition circuitry 21, a fourth acquisition circuitry 22, a second classification circuitry 23, and a classification result determination circuitry 24.

The third acquisition circuitry 21 is configured to acquire a to-be-classified image and at least two candidate labels.

The fourth acquisition circuitry 22 is configured to acquire semantic features of the at least two candidate labels from the at least two candidate labels. In an optional embodiment, the fourth acquisition circuitry 22 inputs all candidate labels into a semantic encoder for semantic mapping to acquire semantic features of the candidate labels. As illustrated in FIG. 6, there are T candidate labels, and accordingly semantic features with a dimension of T×d are acquired.

The second classification circuitry 23 is configured to input the to-be-classified image and the semantic features of the at least two candidate labels into a multi-label image classification model for classification processing, to acquire a correlation between the to-be-classified image and the at least two candidate labels, and a prediction result of mapping the to-be-classified image to the at least two candidate labels, where the multi-label image classification model is acquired by the above apparatus provided in the embodiment as illustrated in FIG. 9.

In the embodiment, as illustrated in FIG. 7, the second classification circuitry 23 inputs an image (i.e., the to-be-classified image) into a visual encoder of the multi-label image classification model to acquire visual features, and the fourth acquisition circuitry 22 inputs all candidate labels into the semantic encoder to acquire the semantic features. The second classification circuitry 23 inputs the visual features and the semantic features into a trained contrastive learning network to acquire a correlation p_{d} between the image to be classified and each candidate label. The second classification circuitry 23 further sends the visual features to a fully connected network for fully connected mapping to acquire the prediction result pᵥ of mapping the to-be-classified image to each classification label (i.e., prediction probability of each classification label).

In an optional embodiment, core content of the contrastive learning network in the prediction stage is illustrated in FIG. 8. The second classification circuitry 23 multiplies the 1×d visual features X with the T×d semantic features Y one by one to calculate cosine similarity of the visual features on each candidate label (that is, a correlation between the to-be-classified image and each candidate label). Referring to FIG. 8, assuming that there are T candidate labels, the cosine similarity includes x₁·y₁, x₁·y₂, . . . x₁·y_{T}.

Referring to FIG. 10, the classification result determination circuitry 24 is configured to determine a classification result of the to-be-classified image based on the correlation and the prediction result. After the prediction result of the fully connected network and the correlation of the contrastive learning network are acquired respectively, the classification result of the to-be-classified image may be p=λpᵥ+(1−λ)p_{d}, where pᵥ is the prediction result of the fully connected network, p_{d} is the correlation of the contrastive learning network, and λ is a weight parameter having a same value as the learnable hyperparameter in the training stage. The learnable hyperparameter λ in the training stage may be adjusted according to the classification result.

In an optional embodiment, the classification result determination circuitry 24 may set a label threshold of the classification result according to actual conditions. For example, if the classification result is above 0.5, it indicates that the candidate label is a label corresponding to the to-be-classified image.

For example, assuming that the candidate labels of the to-be-classified image include hats, tops, pants, shoes, scarves and skirts, the correlation between the to-be-classified image and the candidate labels is acquired as [0.1, 0.2, 0.3, 0.7, 0.5, 0.6] through classification performed by the multi-label image classification model. And the prediction result of the to-be-classified image being mapped to the candidate labels is [0.3, 0.2, 0.4, 0.4, 0.3, 0.6]. If λ is 0.5, the classification result is calculated to be [0.15, 0.2, 0.35, 0.55, 0.4, 0.6], where these values correspond to hats, tops, pants, shoes, scarves and skirts in order, and the candidate labels with a value greater than 0.5 are set as the labels of the to-be-classified image. From above, the traditional fully connected network predicts that the label of the to-be-classified image is only skirt, while the labels of the to-be-classified image acquired in the embodiment include shoes and skirt.

An embodiment provides an electronic device, which includes a memory, a processor, and a computer program stored in the memory and used to run on the processor. When the processor executes the program, the multi-label image classification model training method provided in the embodiment as illustrated in FIG. 1 and the multi-label image classification method provided in the embodiment as illustrated in FIG. 5 are implemented.

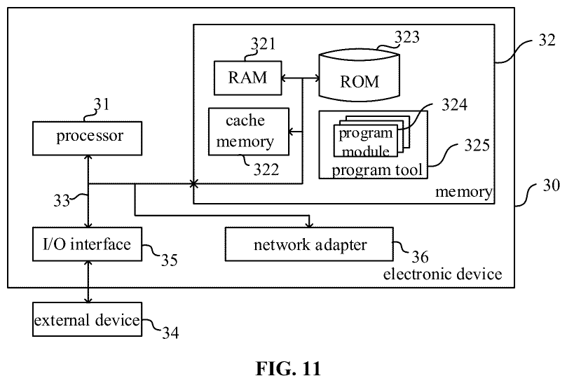

An electronic device 30 illustrated in FIG. 11 is merely an example and should not limit functions and usage scope of the embodiments of the present disclosure.

The electronic device 30 may be in a form of a general-purpose computing device, for example, it may be a server device. Components of the electronic device 30 may include but are not limited to: at least one processor 31, at least one memory 32, and a bus 33 connecting different system components (including the memory 32 and the processor 31).

The bus 33 includes a data bus, an address bus, and a control bus.

The memory 32 may include a volatile memory, such as a Random Access Memory (RAM) 321 and a cache memory 322, and may further include a Read Only Memory (ROM) 323.

The memory 32 may further include a program tool 325 having a set (at least one) of program modules 324, such program modules 324 including but not limited to: an operating system, one or more application programs, other program modules and program data, each of which or any combination of which may include implementation of a network environment.

The processor 31 executes various functional applications and data processing by running the computer program stored in the memory 32, such as the multi-label image classification model training method provided in the embodiment as illustrated in FIG. 1 and the multi-label image classification method provided in the embodiment as illustrated in FIG. 5.

The electronic device 30 may further communicate with one or more external devices 34. Such communication may be performed via an Input/Output (I/O) interface 35. Further, the electronic device 30 may also communicate with one or more networks via a network adapter 36. As illustrated in FIG. 11, the network adapter 36 communicates with other modules of the electronic device 30 via a bus 33. It should be understood that, although not illustrated in FIG. 11, other hardware and/or software modules may be used in conjunction with the electronic device 30, including but not limited to: microcode, device drivers, redundant processors, external disk drive arrays, RAID (disk array) systems, tape drives, and data backup storage systems.

It should be noted that although several units/modules or sub-units/modules of the electronic device are mentioned in the above detailed description, the division is merely exemplary and not mandatory. In fact, according to embodiments of the present disclosure, the features and functions of two or more units/modules described above can be embodied in one unit/module. Conversely, the features and functions of one unit/module described above can be further divided into multiple units/modules to be embodied.

An embodiment provides a computer readable storage medium having a computer program stored thereon. When the program is executed by a processor, the multi-label image classification model training method provided in the embodiment as illustrated in FIG. 1 and the multi-label image classification method provided in the embodiment as illustrated in FIG. 5 are implemented.

The readable storage medium may include but is not limited to: a portable disk, a hard disk, a RAM, a ROM, an erasable programmable read-only memory, an optical storage device, a magnetic storage device or any suitable combinations of the above.

In an optional embodiment, the present disclosure can also be implemented in a form of a program product, which includes a program code. When the program product is run on a terminal device, the program code is configured to enable the terminal device to execute the multi-label image classification model training method provided in the embodiment as illustrated in FIG. 1 and the multi-label image classification method provided in the embodiment as illustrated in FIG. 5.

The program code for executing the present disclosure may be written in any combination of one or more programming languages, and may be executed entirely on a user equipment, partially on a user device, as an independent software package, partially on a user equipment and partially on a remote device, or entirely on a remote device.

Although the specific embodiments of the present disclosure are described above, it should be understood by those skilled in the art that this is only for illustration and the scope of the present disclosure is defined by the appended claims. Those skilled in the art may make various changes or modifications to these embodiments without departing from the principles and essence of the present disclosure, but these changes and modifications all fall within the scope of the present disclosure.

1. A multi-label image classification model training method, comprising:
acquiring a plurality of training samples, wherein the plurality of training samples comprise sample images and label sets corresponding to the sample images, and each of the label sets comprise at least two classification labels;
acquiring semantic features of the label sets from the classification labels;
inputting the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network;
constructing a correlation matrix and a unit matrix corresponding to the correlation matrix based on the correlation; and
calculating a target loss based on the correlation matrix, the unit matrix, the prediction result and the classification labels, and adjusting parameters of the multi-label image classification model based on the target loss until a convergence condition is met.

2. The method according to claim 1, wherein the visual encoder comprises a convolutional neural network and a Transformer network, and said acquiring the visual features from the sample images based on the visual encoder comprises:
inputting the sample images into the convolutional neural network for feature extraction to acquire a corresponding feature map;
flattening the feature map to acquire a first feature;
inputting the first feature into the Transformer network for encoding processing to acquire a second feature; and
generating the visual features based on the second feature.

3. The method according to claim 1, wherein said acquiring the semantic features of the label sets from the classification labels comprises:
inputting the classification labels into a semantic encoder for semantic mapping respectively to acquire semantic features of the classification labels;
acquiring weight parameters of the classification labels; and
generating the semantic features of the label sets based on the weight parameters and the semantic features of the classification labels.

4. The method according to claim 1, wherein said calculating the target loss based on the correlation matrix, the unit matrix, the prediction result and the classification labels comprises:
calculating a first loss based on the correlation matrix and the unit matrix;
calculating a second loss based on the prediction result and the classification labels; and
determining the target loss based on the first loss and the second loss.

5. The method according to claim 4, wherein the first loss comprises a row loss and a column loss, and said calculating the first loss based on the correlation matrix and the unit matrix comprises:
substituting the correlation matrix and the unit matrix into a first loss function to acquire the row loss, wherein the first loss function comprises:
$${L}_{x} = \frac{1}{N} {\sum }_{i = 1}^{N} {\sum }_{j = 1}^{N} [ {e}_{i j} log ( σ ( {M}_{i j} ) ) + ( 1 - {e}_{i j} ) log ( 1 - σ ( {M}_{i j} ) ) ] ,$$
where Lₓ is the row loss, Mᵢⱼ is an element in i-th row and j-th column of the correlation matrix, eᵢⱼ is an element in i-th row and j-th column of the unit matrix, σ( ) is an activation function, and N is a number of the sample images;
substituting the correlation matrix and the unit matrix into a second loss function to acquire the column loss, wherein the second loss function comprises:
$${L}_{y} = \frac{1}{N} {\sum }_{i = 1}^{N} {\sum }_{j = 1}^{N} [ {e}_{j i} log ( σ ( {M}_{j i} ) ) + ( 1 - {e}_{j i} ) log ( 1 - σ ( {M}_{j i} ) ) ] ,$$
wherein L_{y} is the column loss, Mⱼᵢ is an element in j-th row and i-th column of the correlation matrix, eⱼᵢ is an element in j-th row and i-th column of the unit matrix, σ( ) is the activation function, and N is the number of the sample images; and
determining the first loss based on the row loss and the column loss; and/or,
said calculating a second loss based on the prediction result and the classification labels comprises:
substituting the prediction result and the classification labels into a third loss function to acquire the second loss, wherein the third loss function comprises:
$${L}_{v} = \frac{1}{N} {\sum }_{k = 1}^{N} {\sum }_{t = 1}^{T} [ {g}_{kt} log ( σ ( {𝓋}_{kt} ) ) + ( 1 - {g}_{kt} ) log ( 1 - σ ( {𝓋}_{kt} ) ) ] ,$$
where Lᵥ is the second loss, gₖₜ is a true label value of a k-th sample image mapped to a t-h classification label, [symbol] ₖₜ is the prediction result value of the k-th sample image mapped to the t-th classification label, σ( ) is the activation function, N is the number of the sample images, and T is a number of the classification labels.

6. A multi-label image classification method, comprising:
acquiring a to-be-classified image and at least two candidate labels;
acquiring semantic features of the at least two candidate labels from the at least two candidate labels;
inputting the to-be-classified image and the semantic features of the at least two candidate labels into a multi-label image classification model for classification processing, to acquire a correlation between the to-be-classified image and the at least two candidate labels, and a prediction result of mapping the to-be-classified image to the at least two candidate labels, wherein the multi-label image classification model is acquired by the method according to claim 1; and
determining a classification result of the to-be-classified image based on the correlation and the prediction result.

7. (canceled)

8. (canceled)

9. An electronic device comprising a memory, a processor, and a computer program stored in the memory and configured to run on the processor, wherein when the computer program is executed by the processor, cause the processor to:
acquire a plurality of training samples, wherein the plurality of training samples comprise sample images and label sets corresponding to the sample images, and each of the label sets comprise at least two classification labels;
acquire semantic features of the label sets from the classification labels;
input the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network;
construct a correlation matrix and a unit matrix corresponding to the correlation matrix based on the correlation; and
calculate a target loss based on the correlation matrix, the unit matrix, the prediction result and the classification labels, and adjusting parameters of the multi-label image classification model based on the target loss until a convergence condition is met.

10. A computer readable storage medium storing one or more programs, the one or more programs comprising computer instructions, which, when executed by a processor, cause the processor to:
acquire a plurality of training samples, wherein the plurality of training samples comprise sample images and label sets corresponding to the sample images, and each of the label sets comprise at least two classification labels;
acquire semantic features of the label sets from the classification labels;
input the sample images and the semantic features of the label sets into a multi-label image classification model, wherein the multi-label image classification model acquires visual features from the sample images based on a visual encoder, acquires a correlation between the sample images and the label sets by processing the visual features and the semantic features based on a contrastive learning network, and acquires a prediction result of mapping the sample images to the classification labels by processing the visual features based on a fully connected network;
construct a correlation matrix and a unit matrix corresponding to the correlation matrix based on the correlation; and
calculate a target loss based on the correlation matrix, the unit matrix, the prediction result and the classification labels, and adjusting parameters of the multi-label image classification model based on the target loss until a convergence condition is met.

11. An electronic device comprising a memory, a processor, and a computer program stored in the memory and configured to run on the processor, wherein when the computer program is executed by the processor, cause the processor to:
acquire a to-be-classified image and at least two candidate labels;
acquire semantic features of the at least two candidate labels from the at least two candidate labels;
input the to-be-classified image and the semantic features of the at least two candidate labels into a multi-label image classification model for classification processing, to acquire a correlation between the to-be-classified image and the at least two candidate labels, and a prediction result of mapping the to-be-classified image to the at least two candidate labels, wherein the multi-label image classification model is acquired by the method according to claim 1; and
determine a classification result of the to-be-classified image based on the correlation and the prediction result.

12. A computer readable storage medium having a computer program stored thereon, wherein when the computer program is executed by a processor, the method according to claim 6 is implemented.
